(19) United States
(12) Patent Application Publication
(10) Pub. No.: US 2025/0383619 A1
(43) Pub. Date: Dec. 18, 2025

(54) SHEET CONVEYANCE DEVICE AND IMAGE FORMING APPARATUS

(71) Applicant: CANON KABUSHIKI KAISHA, Tokyo (JP)

(72) Inventors: YUYA HAMAJI, Chiba (JP); YUKINOJO TODA, Saitama (JP)

(21) Appl. No.: 19/229,675

(22) Filed: Jun. 5, 2025

(30) Foreign Application Priority Data
Jun. 13, 2024 (JP) 2024-096300

(51) Int. Cl. G03G 15/00

(52) U.S. Cl. CPC G03G 15/6573; G03G 15/5004; G03G 15/6552; G03G 15/6579

(57) ABSTRACT

A sheet conveyance device includes first and second conveyance paths, a switching member, a moving mechanism, and a control unit, wherein when the control unit starts energization of a solenoid, the switching member is moved from a second position to a first position, wherein when the control unit stops energization of the solenoid, the switching member is moved from the first position to the second position, wherein a first timing is a timing earlier than a timing when a leading edge of a sheet reaches the switching member, and a second timing is a timing when a trailing edge of a preceding sheet passes through a position downstream of the switching member, and wherein in a case where the switching member is moved from the first position to the second position, the control unit stops energization of the solenoid at an earlier timing of the first and second timings.

### BACKGROUND

### Field

The present disclosure relates to a sheet conveyance device configured to convey a sheet, and to an image forming apparatus configured to form an image on the sheet.

### Description of the Related Art

Japanese Patent Application Laid-Open No. 2024-52242 discusses an image forming apparatus in which a position of a switching member is moved to switch a sheet conveyance path. In the image forming apparatus discussed in Japanese Patent Application Laid-Open No. 2024-52242, path switching operation is controlled using a sensor disposed on an upstream side of the switching member in a conveyance direction. In other words, the switching member switches the path based on a fact that a leading edge of a sheet reaches a predetermined position on the upstream side of the switching member in a sheet conveyance direction.

However, operation of the switching member may be delayed due to abrasion of a moving mechanism for moving the switching member and the like. In such a case, switching of the path by the switching member may be late for conveyance of the sheet, and damage or jam of the sheet may occur.

### SUMMARY

The present disclosure is directed to a sheet conveyance device and an image forming apparatus that perform stable switching operation.

According to some embodiments, a sheet conveyance device includes a first conveyance path and a second conveyance path through which a sheet is conveyed, a switching member configured to be switched to a first position for guiding a conveyed sheet to the first conveyance path and a second position for guiding a conveyed sheet to the second conveyance path, a moving mechanism including a driving source and configured to move a position of the switching member, and a control unit configured to control the driving source, wherein a first timing is a timing when a leading edge of a sheet reaches a position upstream by a first predetermined distance from the switching member in a sheet conveyance direction, and a second timing is a timing when a trailing edge of a preceding sheet conveyed before the sheet passes through a position downstream by a second predetermined distance from the switching member in the sheet conveyance direction, and wherein the control unit controls the driving source so that the switching member switches a path through which a sheet is conveyed at the first timing in a case where the first timing is earlier than the second timing, and the control unit controls the driving source so that the switching member switches a path through which a sheet is conveyed at the second timing in a case where the second timing is earlier than the first timing.

According to another embodiment, a sheet conveyance device includes a first conveyance path and a second conveyance path through which a sheet is conveyed, a switching member configured to be switched to a first position for guiding a conveyed sheet to the first conveyance path and a second position for guiding a conveyed sheet to the second conveyance path, a moving mechanism including a driving source and configured to move a position of the switching member, and a control unit configured to control the driving source, wherein the control unit controls the driving source so that the switching member switches a path through which a sheet is conveyed at a first timing in a case where a sheet interval between a trailing edge of a preceding sheet and a leading edge of a succeeding sheet conveyed after the preceding sheet is short, and the control unit controls the driving source so that the switching member switches a path through which a sheet is conveyed at a second timing earlier than the first timing in a case where the sheet interval is long.

Further features of the present disclosure will become apparent from the following description of exemplary embodiments with reference to the attached drawings.

### BRIEF DESCRIPTION OF THE DRAWINGS

FIG. 1 is a cross-sectional view illustrating an entire image forming apparatus according to exemplary embodiments.

FIG. 2A is a diagram illustrating a switching member positioned at a first position, and FIG. 2B is a diagram illustrating the switching member positioned at a second position.

FIG. 3A is a flowchart of path control to move the switching member from the second position to the first position according to a first exemplary embodiment, and FIG. 3B is a flowchart of path control to move the switching member from the first position to the second position according to the first exemplary embodiment.

FIG. 4 is a block diagram illustrating a system configuration.

FIG. 5 is a cross-sectional view illustrating arrangement relationship between the switching member and a sheet according to the first exemplary embodiment.

FIG. 6A is a cross-sectional view illustrating arrangement relationship between the switching member and sheets at a first timing according to the first exemplary embodiment, and FIG. 6B is a cross-sectional view illustrating arrangement relationship between the switching member and the sheets at a second timing according to the first exemplary embodiment.

FIG. 7A is a flowchart of path control to move a switching member from a first position to a second position according to a second exemplary embodiment, and FIG. 7B is a flowchart of path control to move the switching member from the second position to the first position according to the second exemplary embodiment.

FIG. 8 is a cross-sectional view illustrating arrangement relationship between the switching member and a sheet according to the second exemplary embodiment.

FIG. 9A is a cross-sectional view illustrating arrangement relationship between the switching member and the sheet at a first timing according to the second exemplary embodiment, and FIG. 9B is a cross-sectional view illustrating arrangement relationship between the switching member and the sheet at a second timing according to the second exemplary embodiment.

FIG. 10A is a cross-sectional view of a moving mechanism when the switching member is at the first position according to the first exemplary embodiment, and FIG. 10B is a cross-sectional view of the moving mechanism when the switching member is at the second position according to the first exemplary embodiment.

FIG. 11A is a cross-sectional view of a moving mechanism when the switching member is at the first position according to the second exemplary embodiment, and FIG. 11B is a cross-sectional view of the moving mechanism when the switching member is at the second position according to the second exemplary embodiment.

### DESCRIPTION OF THE EMBODIMENTS

Some exemplary embodiments of the present disclosure are described with reference to drawings. Dimensions, materials, shapes, relative positions, and the like of components described in the exemplary embodiments are not intended to limit the scope of the present disclosure only to them unless otherwise particularly specified. A first exemplary embodiment is described.

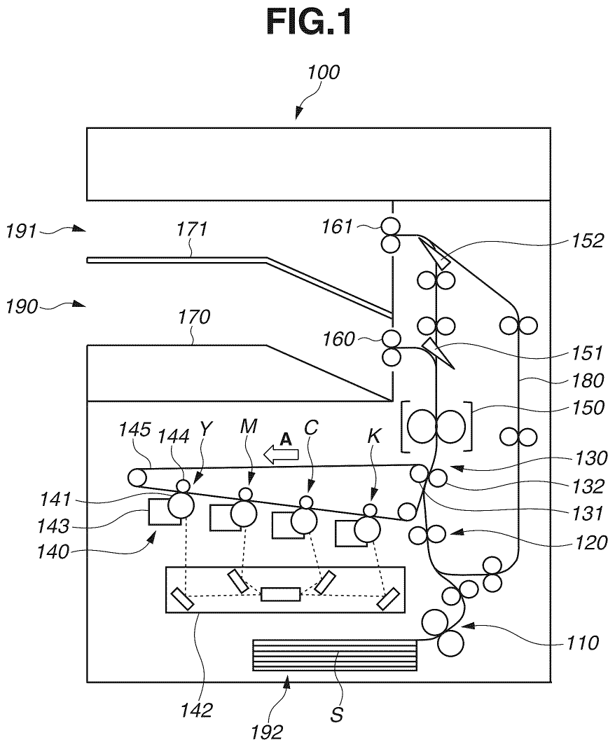

FIG. 1 is a cross-sectional view of an image forming apparatus 100 of an intermediate transfer tandem type in which image forming units for four colors are arranged side by side on an intermediate transfer belt. A sheet S is stored so as to be stacked on a lift-up device included in a sheet conveyance device 192, and is fed by a sheet feeding unit 110 in synchronization with an image formation timing of the image forming apparatus 100. The sheet S fed by the sheet feeding unit 110 passes through a conveyance path, and is conveyed to a skew correction device 120. After the skew correction device 120 performs skew correction and timing correction of the sheet S, the sheet S is sent to a secondary transfer unit 130. The secondary transfer unit 130 is a toner image transfer nip unit including a secondary transfer inner roller 131 and a secondary transfer outer roller 132 substantially facing each other, and transfers a toner image to the sheet S by applying predetermined pressing force and an electrostatic load bias.

An image formation process of the toner image sent to the secondary transfer unit 130 at a timing is described. The timing is similar to the timing of a conveyance process of the sheet S up to the secondary transfer unit 130 described above

Each of image forming units 140 mainly includes a photosensitive body 141, an exposure device 142, a developing device 143, and a primary transfer device 144. The exposure device 142 emits light based on a sent signal of image information to the photosensitive body 141 having a surface uniformly charged by a charging unit in advance, thereby forming an electrostatic latent image appropriately through a deflection unit and the like. The developing device 143 performs toner development on the electrostatic latent image formed on the photosensitive body 141 in the above-described manner, which results in formation of the toner image on the photosensitive body 141. Thereafter, the primary transfer device 144 applies predetermined pressing force and an electrostatic load bias to transfer the toner image onto an intermediate transfer belt 145. The image forming units 140 described above are provided for four colors of yellow (Y), magenta (M), cyan (C), and black (K).

The intermediate transfer belt 145 is described. The intermediate transfer belt 145 is driven and conveyed in a direction of an arrow A illustrated in FIG. 1. Accordingly, the image formation processes by the respective image forming units for Y, M, C, and K described above are performed in parallel. The image formation processes of the respective colors are performed at timings such that the toner image is superimposed on the upstream toner image primarily-transferred onto the intermediate transfer belt 145. As a result, a full-color toner image is finally formed on the intermediate transfer belt 145, and is conveyed to the secondary transfer unit 130.

By the conveyance process of the sheet S and the image formation process described above, the full-color toner image is secondarily transferred onto the sheet S by the secondary transfer unit 130. Thereafter, the sheet S is conveyed to a fixing device 150. The fixing device 150 melts and fixes the toner onto the sheet S by applying predetermined pressing force by rollers substantially facing each other, a belt, or the like, and heat by a heat source such as a heater. The sheet S having a fixed image thereon obtained in the above-described manner is discharged onto a lower sheet discharge tray 170 included in a lower sheet discharge unit 190 by a first sheet discharge roller 160, or is conveyed toward a second sheet discharge roller 161. At this time, a conveyance path through which the sheet S is conveyed is branched by a first switching member 151. The sheet S conveyed to the second sheet discharge roller 161 is discharged onto an upper sheet discharge tray 171 included in an upper sheet discharge unit 191, or is conveyed to a duplex-printing conveyance path 180 in a case of duplex printing. In the case of duplex printing, after a trailing edge of the sheet S passes over a second switching member 152, the sheet S is conveyed to the duplex-printing conveyance path 180 by reverse operation of the second sheet discharge roller 161. The sheet S having passed through the duplex-printing conveyance path 180 is subjected to the skew correction and the timing correction by the skew correction device 120 again. Thereafter, the sheet S is sent to the secondary transfer unit 130, an image for a second surface is transferred to the sheet S, and the image is fixed by the fixing device 150. The sheet S is discharged onto the lower sheet discharge tray 170 or the upper sheet discharge tray 171. In other words, the duplex-printing conveyance path 180 is a conveyance path for conveying the sheet S in which the image has been formed on one surface, to the secondary transfer unit 130 again in the case of duplex printing. Each of the lower sheet discharge tray 170 and the upper sheet discharge tray 171 on which the sheet S discharged in the above-described manner is stacked includes an upward inclined surface from an upstream to a downstream in a discharge direction of the sheet S. For this reason, the discharged sheet S is aligned on the upstream side in the discharge direction by an own weight of the sheet S.

### Configuration of Switching Member

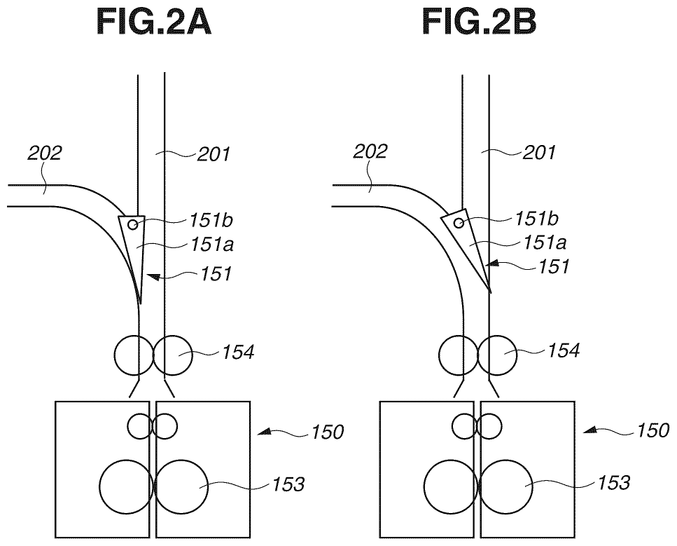

Details of the configuration in a vicinity of the switching member 151 according to the first exemplary embodiment is descried with reference to FIGS. 2A and 2B. FIGS. 2A and 2B are schematic cross-sectional views illustrating the vicinity of the switching member 151. FIG. 2A illustrates the switching member 151 positioned at a first position, and FIG. 2B illustrates the switching member 151 positioned at a second position. The switching member 151 includes a guide member 151a and a shaft 151b integrated with each other, and pivots around the shaft 151b. By a driving source P described below, the switching member 151 is moved to the first position (FIG. 2A) for guiding the sheet S to a first conveyance path 201. In the present exemplary embodiment, the first conveyance path 201 is a path toward the upper sheet discharge tray 171 or the duplex-printing conveyance path 180. By stopping driving of the driving source P, the switching member 151 is moved to the second position (FIG. 2B) for guiding the sheet S to a second conveyance path 202, by a spring 155 as a pressing member O or action of own weight. In the present exemplary embodiment, the second conveyance path 202 is a path toward the lower sheet discharge tray 170.

### Configuration of Moving Mechanism

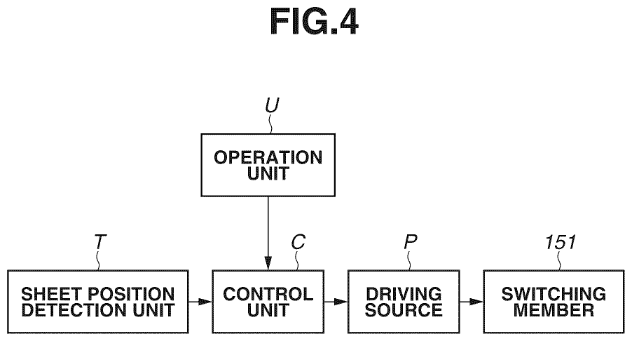

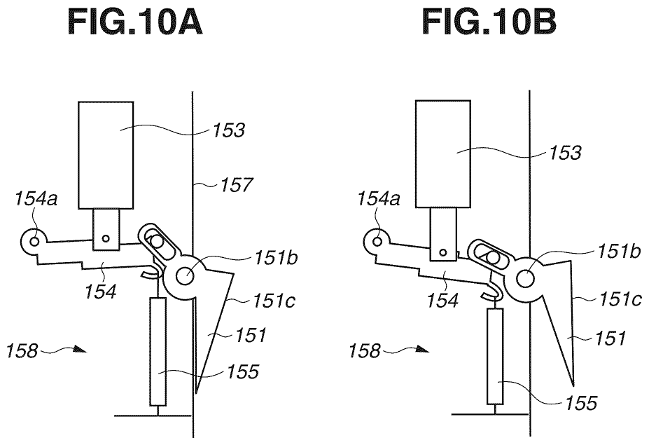

A moving mechanism according to the first exemplary embodiment is described with reference to FIGS. 10A and 10B. A moving mechanism 158 includes a solenoid 153 serving as the driving source P, a link member 154, and the spring 155 serving as the pressing member. The link member 154 pivots around a fulcrum 154a, and is coupled to the solenoid 153 so as to be freely pivotable. The link member 154 is also coupled to the switching member 151. The spring 155 is disposed below the link member 154, and is coupled to the link member 154. A control unit C (see FIG. 4) described below can supply power to the driving source P, and switches an operation between supply and supply stop of the power to the driving source P. In other words, the control unit C switches a state of the solenoid 153 serving as the driving source P between an energized state (on) and a non-energized state (off).

FIG. 10A illustrates the moving mechanism 158 when the switching member 151 is at the first position, and FIG. 10B illustrates the moving mechanism 158 when the switching member 151 is at the second position. Switching of the position of the switching member 151 from the second position to the first position is described. When the power is supplied by the control unit C in the state illustrated in FIG. 10B, the solenoid 153 is attracted, and a front end of the link member 154 is lifted up. The switching member 151 is rotated around the shaft 151b in a clockwise direction, and is moved to the first position. At this time, by making attraction force of the solenoid 153 greater than urging force of the spring 155, the switching member 151 is rotated in the clockwise direction. After rotated in the clockwise direction, the switching member 151 comes into contact with a plate 157 and is stopped. The position is the first position of the switching member 151. In contrast, switching of the position of the switching member 151 from the first position to the second position is described. When power supply by the control unit C is stopped, attraction of the solenoid 153 is stopped, and the front end of the link member 154 is lowered by the urging force of the spring 155 and an own weight of an iron core of the solenoid 153. The switching member 151 is rotated around the shaft 151b in a counterclockwise direction, and is moved to the second position. After the switching member 151 is rotated in the counterclockwise direction, a stopper portion 151c of the switching member 151 comes into contact with a contact portion of a guide disposed at a position facing the switching member 151, thereby stopping the switching member 151.

The position is the second position of the switching member 151. In other words, when the solenoid 153 serving as the driving source P is energized, the switching member 151 is moved to the first position. When the solenoid 153 serving as the driving source P is not energized, the switching member 151 is moved to the second position. In other words, when the driving source P is driven, the switching member 151 is moved to the first position, and when the driving of the driving source P is stopped, the switching member 151 is moved to the second position.

### Details of Path Switching Control

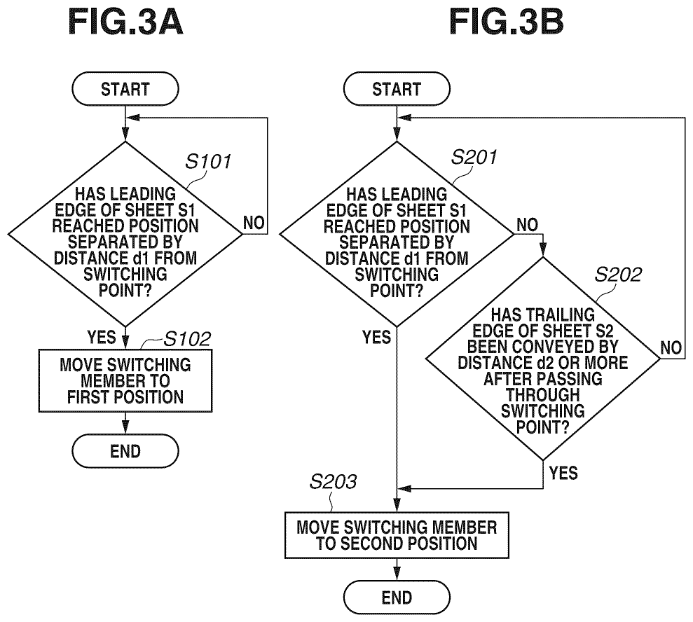

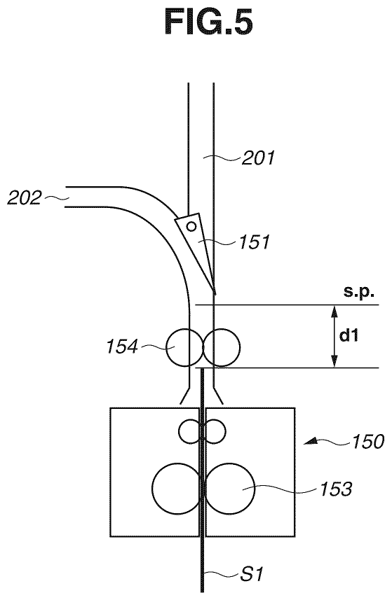

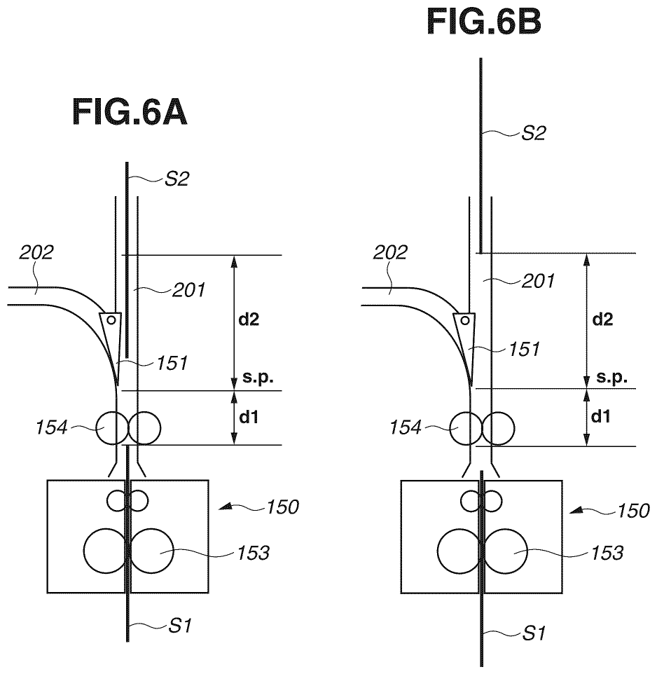

Sheet conveyance path switching control according to the present exemplary embodiment is described with reference to FIGS. 3A and 3B, 4, 5, 6A and 6B. FIG. 3A is a flowchart of the path control to move the switching member 151 from the second position to the first position, and FIG. 3B is a flowchart of the path control to move the switching member 151 from the first position to the second position. FIG. 4 is a block diagram illustrating a system configuration. FIG. 5 is a diagram illustrating arrangement relationship between the switching member 151 and a sheet when the switching member 151 is moved from the second position to the first position. FIGS. 6A and 6B are diagrams illustrating arrangement relationship between the switching member 151 and sheets when the switching member 151 is moved from the first position to the second position.

The system configuration is described with reference to FIG. 4. As illustrated in FIG. 4, the image forming apparatus 100 includes an operation unit U, the control unit C, a sheet position detection unit T. The operation unit U receives operation of an image formation start instruction and the like from a user. The sheet position detection unit T is a timer for specifying a position of the conveyed sheet S. The control unit C is connected to the sheet position detection unit T and the driving source P, and controls the driving source P based on the sheet position detection unit T. To convey the sheet S to the first conveyance path 201 or the second conveyance path 202, the control unit C drives the driving source P at a predetermined timing described below corresponding to setting of the operation unit U, and moves the switching member 151 to the first position or the second position. More specifically, based on information on a type of the sheet (length, thickness, material, etc. of sheet) set by the operation unit U and the timer as the sheet position detection unit T, the control unit C estimates a time when the sheet reaches the predetermined position, and determines a timing of driving the driving source P.

In the present exemplary embodiment, the timer is used as the sheet position detection unit T. When a print job is started, a TOP signal for causing the image forming units 140 to start drawing of the toner images, corresponding to each sheet, is output. The control unit C estimates a time when the sheet reaches the predetermined position described below, with the TOP signal corresponding to each sheet as a trigger. A memory stores, for each type of the sheet, a desired time from output of the TOP signal until a leading edge of the sheet reaches a position upstream by a distance d1 from a switching point described below. The memory further stores, for each type of the sheet, a desired time from output of the TOP signal until a trailing edge of the sheet reaches a position downstream by a distance d2 from the switching point described below. The upstream indicates an upstream in the sheet conveyance direction, and the downstream indicates a downstream in the sheet conveyance direction. The control unit C estimates, from the output timing of the TOP signal and the above-described desired times stored in the memory, a timing when the leading edge of the sheet reaches the position upstream by the distance d1 from the switching point and a timing when the trailing edge of the sheet reaches the position downstream by the distance d2 from the switching point. The control unit C switches control of the driving source P at an earlier timing of a first timing when a leading edge of a sheet S1 reaches the position upstream by the distance d1 from the switching point and a second timing when a trailing edge of a sheet S2 conveyed before the sheet S1 reaches the position downstream by the distance d2 from the switching point. In the present exemplary embodiment, the TOP signal for causing the image forming units to start drawing of the toner images is used as the trigger of the timer, but a time when the sheet reaches the secondary transfer unit 130 may be used as the trigger. In the present exemplary embodiment, the timer is used as the sheet position detection unit T, but a sensor may be used as the sheet position detection unit T. In the present exemplary embodiment, since the timer is used and no sensor is provided around the switching member 151, the number of components can be reduced, and space saving and cost reduction can be achieved.

The flowcharts of the path control are described with reference to FIGS. 3A and 3B, FIG. 5, and FIGS. 6A and 6B. By increase in sliding resistance of the moving mechanism based on the number of times of operation of the switching member 151, there may be a difference between a switching timing of power supply to the driving source P by the control unit C and an actual timing when the moving operation of the switching member 151 to the first position or the second position is completed. In particular, mechanical response in a case where the control unit C stops power supply to the driving source P and the solenoid returns to a state before driving is lower than mechanical response in a case where the control unit C starts power supply to the driving source P and the solenoid is attracted. For this reason, in particular, there may be a difference between a timing when the control unit C stops power supply to the driving source P and a timing when the switching operation of the switching member 151 is completed.

Details of operation to move the switching member 151 from the second position to the first position by driving the driving source P are described with reference to FIG. 3A and FIG. 5. The above-described operation is operation of transiting from FIG. 2B to FIG. 2A. FIG. 5 is a cross-sectional view substantially illustrating the vicinity of the switching member 151 when the leading edge of the sheet S1 reaches a position upstream by the distance d1 from a switching point s.p. by the distance d1. The switching point s.p. is a position where a front end of the switching member 151 is positioned in the sheet conveyance direction. In a case where the switching member 151 is moved from the second position to the first position, at the timing when the leading edge of the sheet S1 reaches the position upstream by the distance d1 from the switching point s.p. (YES in step S101 of FIG. 3A), the control unit C drives the driving source P to move the switching member 151 in step S102 of FIG. 3A. The timing when the leading edge of the sheet S1 reaches the position upstream by the distance d1 from the switching point s.p. is the first timing. In this case, the difference between the timing of the input signal to the driving source P and the operation completion timing of the switching member 151 is minute, and the path switching can be controlled while a time interval between a completion time of the conveyance path switching and the time when the sheet S1 reaches the switching point s.p. is sufficiently secured and substantially maintained.

Details of operation to move the switching member 151 from the first position to the second position by stopping driving of the driving source P are described with reference to FIG. 3B and FIGS. 6A and 6B. The movement of the switching member 151 from the first position to the second position is operation of transiting from FIG. 2A to FIG. 2B. As described above, the switching member 151 is moved from the first position to the second position by stopping power supply by the control unit C and putting the solenoid 153 into the non-energized state. The returning operation by stopping energization to the solenoid 153 is low in mechanical response and takes time, as compared with the attracting operation by energization to the solenoid 153. In other words, mechanical response of the moving mechanism 158 when driving of the driving source P is stopped and the switching member 151 is moved from the first position to the second position is lower than mechanical response of the moving mechanism 158 when the driving source P is driven and the switching member 151 is moved from the second position to the first position.

In other words, as compared with the case where the switching member 151 is moved from the second position to the first position, it takes time to move the switching member 151 from the first position to the second position. In the present exemplary embodiment, to move the switching member 151 from the first position to the second position with time to spare, power supply to the driving source P is stopped at an earlier timing of the first timing and the second timing described below.

A flowchart of path control to move the switching member 151 from the first position to the second position is described with reference to FIG. 3B. FIG. 6A is a cross-sectional view substantially illustrating the vicinity of the switching member 151 when the leading edge of the sheet S1 reaches the position upstream by the distance d1 from the switching point s.p. FIG. 6B is a cross-sectional view substantially illustrating the vicinity of the switching member 151 when the sheet S2 previously conveyed on the downstream of the sheet S1 is further conveyed by the distance d2 after the trailing edge of the sheet S2 has passed through the switching point s.p.

In a case where a distance until the leading edge of the sheet S1 reaches the switching point s.p. is within the distance d1 (YES in step S201 of FIG. 3B, FIG. 6A), the control unit C stops driving of the driving source P, and starts movement of the switching member 151 from the first position to the second position in step S203 of FIG. 3B. The timing when the leading edge of the sheet S1 reaches the position upstream by the distance d1 from the switching point s.p. is the first timing. In a case where the distance until the leading edge of the sheet S1 reaches the switching point s.p. is not within the distance d1 (NO in step S201 of FIG. 3B), it is determined whether the sheet S2 preceding the sheet S1 has been conveyed by the distance d2 or more after the trailing edge of the sheet S2 has passed through the switching point s.p. in step S202 of FIG. 3B. In a case where the sheet S2 has been conveyed by the distance d2 or more after the trailing edge of the sheet S2 has passed through the switching point s.p. (YES in step S202 of FIG. 3B, FIG. 6B), the control unit C stops driving of the driving source P to start movement of the switching member 151 from the first position to the second position in step S203 of FIG. 3B. The timing when the sheet S2 is further conveyed by the distance d2 after the trailing edge of the sheet S2 has passed through the switching point s.p. is the second timing. In other words, the timing when the trailing edge of the preceding sheet conveyed before the sheet S1 reaches the position downstream by the distance d2 from the switching point s.p. is the second timing. Accordingly, the control unit C stops driving of the driving source P at an earlier timing of the first timing when the leading edge of the succeeding sheet S1 reaches the position upstream by the distance d1 from the switching point s.p. and the second timing when the trailing edge of the preceding sheet S2 reaches the position downstream by the distance d2 from the switching point s.p. In other words, in a case where the trailing edge of the preceding sheet S2 passes through the position downstream by the distance d2 from the switching point s.p. at a timing earlier than the timing when the leading edge of the succeeding sheet S1 reaches the position upstream by the distance d1 from the switching point s.p., the control unit C starts movement of the switching member 151. The preceding sheet S2 is a sheet conveyed just before the succeeding sheet S1.

In the present exemplary embodiment, the switching point s.p. is a position where the front end of the switching member 151 is positioned in the sheet conveyance direction. The distance d1 (first predetermined distance) is a distance longer than a distance by which the sheet is conveyed for a predetermined time period from start to completion of switching of the switching member 151. The distance d2 (second predetermined distance) is preferably a distance from the switching point s.p. to the position downstream of the switching member 151 in the sheet conveyance direction. In this case, the trailing edge of the sheet S2 does not come into contact with the switching member 151, which makes it possible to reduce damage of the sheet S2. The distance d2 may be a length about half the length of the switching member 151 as long as damage of the sheet S2 is allowed.

In the present exemplary embodiment, when the switching member 151 is moved from the first position to the second position, driving of the driving source P is stopped at an earlier timing of the first timing and the second timing. However, the two timings are compared not only when the switching member 151 is moved from the first position to the second position. For example, even when the switching member 151 is moved from the second position to the first position, the driving source P may be driven at an earlier timing of the first timing and the second timing. However, as compared with the case where the solenoid 153 serving as the driving source P is driven, mechanical response of the moving mechanism 158 is low in the case where driving of the driving source P is stopped. For this reason, the first timing and the second timing are particularly effectively compared in a case where the control unit C stops driving of the driving source P and the switching member 151 is moved from the first position to the second position. In the present exemplary embodiment, the first timing and the second timing are compared, but the timings are not limited to the first and second timings, and a plurality of timings including a third timing and a fourth timing may be compared. The distance d1 when the switching member 151 is moved from the first position to the second position and the distance d1 when the switching member 151 is moved from the second position to the first position may be different from each other.

In the present exemplary embodiment, the path switching control of the switching member 151 in the image forming apparatus 100 is described, but the control is not limited to the example. In a post-processing apparatus that is an optional unit, similar control may be performed on a switching member for switching a sheet conveyance path. In the present exemplary embodiment, the moving mechanism 158 includes the solenoid 153, but the configuration is not limited to the example, and the moving mechanism 158 may include a motor.

By increase in sliding resistance of the moving mechanism based on the number of times of operation of the switching member 151, a difference is caused between the driving stop timing of the driving source P and the actual timing when movement of the switching member 151 to the second position or the first position is completed. However, in the present exemplary embodiment, in addition to the path switching timing based on the leading edge position of the sheet S1, the path switching timing based on the trailing edge position of the sheet S2 conveyed before the sheet S1 is added. As a result, the time interval between the completion time of the conveyance path switching and the time when the sheet S1 reaches the switching point s.p. can be sufficiently secured. This makes it possible to perform stable path switching. Such a configuration is particularly effective in a case where a sheet conveyance interval is sufficiently wide.

In the present exemplary embodiment, examples of the case where switching of the switching member 151 at an earlier timing of the first timing and the second timing is effective include a size mixed job and a paper-type mixed job. In a case of a job in which sheets different in length in a conveyance direction such as an A4 sheet and an A3 sheet are mixed, a sheet distance that is a distance between a trailing edge of a preceding sheet and a leading edge of a succeeding sheet is varied in the job. In a case where the sheet distance is large, switching of the switching member 151 is likely to be performed at the second timing based on the trailing edge of the preceding sheet. In a case of the paper-type mixed job, a sheet conveyance speed is varied depending on a type of the sheet. For example, thick paper is conveyed at a speed half a speed of regular paper.

For this reason, since the sheet distance is not constant, using the first timing and the second timing makes it possible to provide a spare time for path switching.

In the first exemplary embodiment, in the case where the switching member 151 is switched from the first position to the second position, operation of the driving source P is switched at an earlier timing of the first timing and the second timing. In a second exemplary embodiment, in the case where the switching member 151 is switched from the second position to the first position, operation of the driving source P is switched at an earlier timing of the first timing and the second timing.

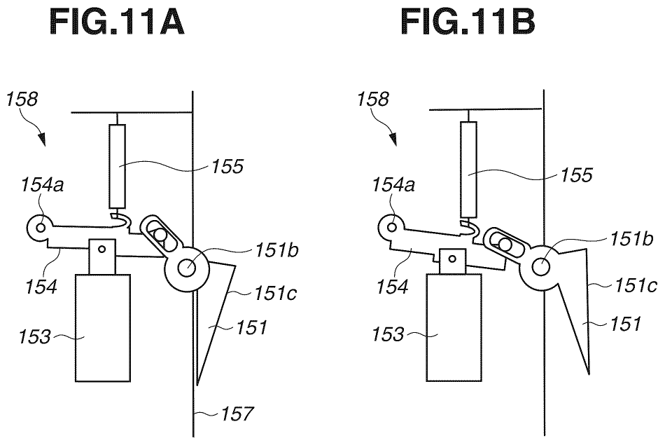

A moving mechanism according to the second exemplary embodiment is described with reference to FIGS. 11A and 11B. The moving mechanism according to the first exemplary embodiment and the moving mechanism according to the second exemplary embodiment are different in arrangement of the solenoid 153 and the spring 155 relative to the link member 154. Details except for the arrangement are similar to the details in the first exemplary embodiment, and accordingly, description of the details except for the arrangement is omitted. As illustrated in FIGS. 10A and 10B, in the first exemplary embodiment, the solenoid 153 is disposed above the link member 154. Accordingly, when the power is supplied to the driving source P by the control unit C, the solenoid 153 is attracted, and the switching member 151 is rotated in the clockwise direction and is moved from the second position to the first position. In contrast, as illustrated in FIGS. 11A and 11B, in the second exemplary embodiment, the solenoid 153 is disposed below the link member 154, and the link member 154 and the solenoid 153 are coupled. The spring 155 is disposed above the link member 154, and is coupled to the link member 154. Accordingly, in the second exemplary embodiment, when the power is supplied to the driving source P by the control unit C, the solenoid 153 is attracted, and the switching member 151 is rotated around the shaft 151b in the counterclockwise direction and is switched from the first position to the second position. As in the first exemplary embodiment, mechanical response in the case where the control unit C stops power supply to the driving source P and the solenoid returns to a state before driving is lower than mechanical response in the case where the control unit C starts power supply to the driving source P and the solenoid is attracted. Accordingly, in the second exemplary embodiment, when the control unit C stops power supply to the driving source P and the switching member 151 is moved from the second position to the first position, the path switching at an earlier timing of the first timing and the second timing is effective.

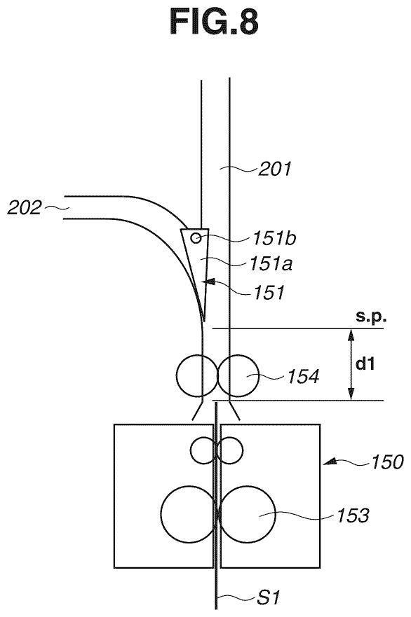

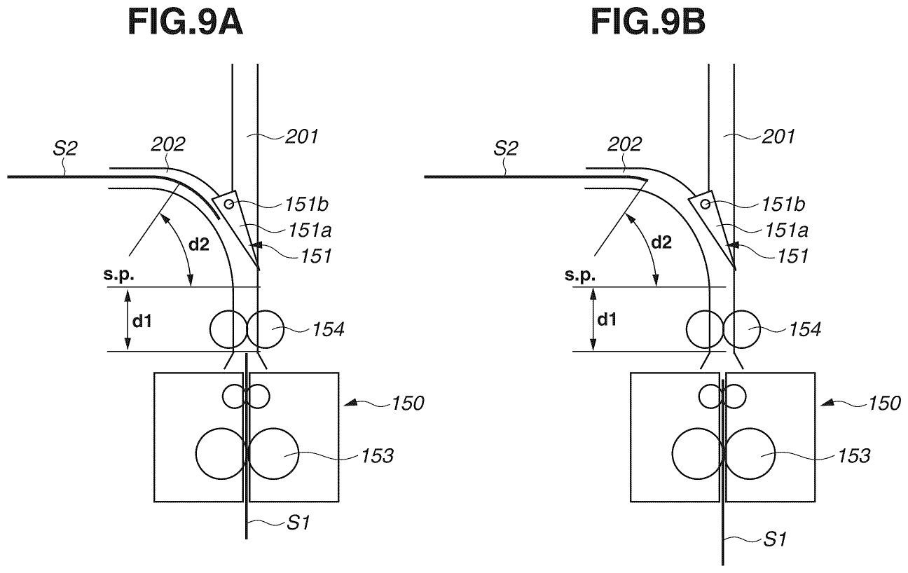

Details of the configuration in the vicinity of the switching member 151 according to the second exemplary embodiment are described with reference to FIG. 8 and FIGS. 9A and 9B. The second exemplary embodiment is similar to the first exemplary embodiment except for the position downstream by the distance d2 from the switching point s.p. In the second exemplary embodiment, the position downstream by the distance d2 from the switching point s.p. is in the second conveyance path 202.

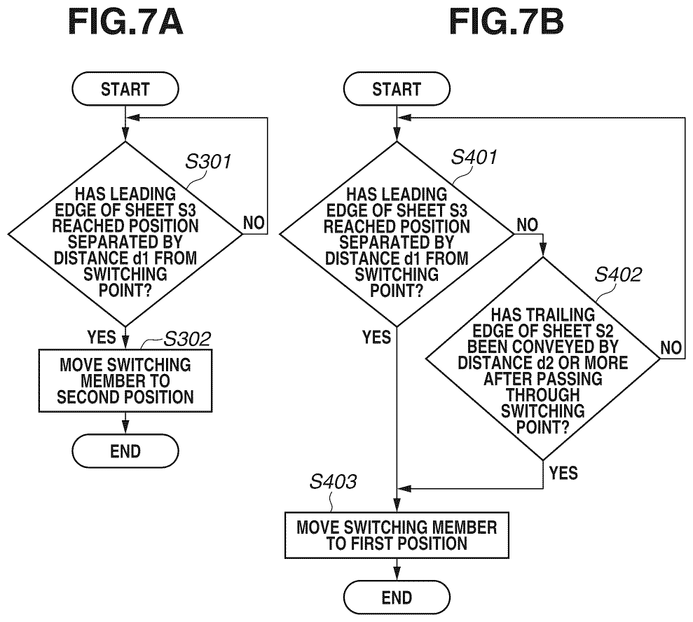

Details of operation to move the switching member 151 from the first position to the second position by driving the driving source P are described with reference to FIG. 7A and FIG. 8. The above-described operation is operation of transiting from FIG. 2A to FIG. 2B. FIG. 8 is a cross-sectional view substantially illustrating the vicinity of the switching member 151 when the leading edge of the sheet S1 reaches the position upstream by the distance d1 from the switching point s.p. In a case where the switching member 151 is moved from the first position to the second position, at a timing when the leading edge of the sheet S1 reaches the position upstream by the distance d1 from the switching point s.p. (YES in step S301 of FIG. 7A), the control unit C drives the driving source P in step S302 of FIG. 7A. The timing when the leading edge of the sheet S1 reaches the position upstream by the distance d1 from the switching point s.p. is the first timing. In this case, the difference between the timing of the input signal to the driving source P and the operation completion timing of the switching member 151 is minute, and the path switching can be controlled while a time interval between a completion time of the conveyance path switching and the time when the sheet S1 reaches the switching point s.p. is sufficiently secured and substantially maintained.

Details of operation to move the switching member 151 from the second position to the first position by stopping driving of the driving source P are described with reference to FIG. 7B and FIGS. 9A and 9B. The movement of the switching member 151 from the second position to the first position is operation of transiting from FIG. 2B to FIG. 2A. As described above, the switching member 151 is moved from the second position to the first position by stopping driving of the driving source P of the solenoid 153. Mechanical response in the case where the control unit C stops power supply to the driving source P and the solenoid returns to a state before driving is lower than mechanical response in the case where the control unit C starts power supply to the driving source P and the solenoid is attracted. In other words, as compared with the case where the switching member 151 is moved from the first position to the second position, it takes time to complete movement of the switching member 151 from the second position to the first position. Accordingly, to move the switching member 151 from the second position to the first position with time to spare, driving of the driving source P is stopped at an earlier timing of the first timing and the second timing described below.

A flowchart of path control to move the switching member 151 from the second position to the first position is described with reference to FIG. 7B. FIG. 9A is a cross-sectional view substantially illustrating the vicinity of the switching member 151 when the leading edge of the sheet S1 reaches the position upstream by the distance d1 from the switching point s.p. according to the second exemplary embodiment. FIG. 9B is a cross-sectional view substantially illustrating the vicinity of the switching member 151 when the sheet S2 previously conveyed on the downstream of the sheet S1 is further conveyed by the distance d2 after the trailing edge of the sheet S2 has passed through the switching point s.p. according to the second exemplary embodiment.

In a case where the leading edge of the sheet S1 reaches the position upstream by the distance d1 from the switching point s.p. (YES in step S401 of FIG. 7B, FIG. 9A), the control unit C stops driving of the driving source P, and starts movement of the switching member 151 from the second position to the first position in step S403 of FIG. 7B. The timing when the leading edge of the sheet S1 reaches the position upstream by the distance d1 from the switching point s.p. is the first timing. In a case where the distance until the leading edge of the sheet S1 reaches the switching point s.p. is not within the distance d1 (NO in step S401 of FIG. 7B), it is determined whether the sheet S2 preceding the sheet S1 has been conveyed by the distance d2 or more after the trailing edge of the sheet S2 has passed through the switching point s.p. in step S402 of FIG. 7B. In a case where the sheet S2 has been conveyed by the distance d2 or more after the trailing edge of the sheet S2 has passed through the switching point s.p. (YES in step S402 of FIG. 7B, FIG. 9B), the control unit C stops driving of the driving source P to start movement of the switching member 151 from the second position to the first position in step S403 of FIG. 7B. The timing when the sheet S2 is further conveyed by the distance d2 after the trailing edge of the sheet S2 has passed through the switching point s.p. is the second timing. In other words, the control unit C stops driving of the driving source P at an earlier timing of the first timing when the leading edge of the succeeding sheet S1 reaches the position upstream by the distance d1 from the switching point s.p. and the second timing when the trailing edge of the preceding sheet S2 reaches the position downstream by the distance d2 from the switching point s.p. The preceding sheet S2 is a sheet conveyed just before the succeeding sheet S1. In other words, in a case where the trailing edge of the sheet S2 preceding the sheet S1 passes through the position downstream by the distance d2 from the switching point s.p. at a timing earlier than the timing when the leading edge of the sheet S1 reaches the position upstream by the distance d1 from the switching point s.p., the control unit C starts movement of the switching member 151.

In the second exemplary embodiment, the case where two movement timings of the switching member are provided when the switching member 151 is moved from the first position to the second position is described. As in the first exemplary embodiment, a time interval between the completion time of the conveyance path switching and the time when the sheet S1 reaches the switching point s.p. can be sufficiently secured. Thus, stable path switching can be expected.

In a modification of the second exemplary embodiment, a case where an effect by the spring is sufficient in arrangement of the moving mechanism according to the first exemplary embodiment illustrated in FIGS. 10A and 10B is described. In this case, a difference between the driving stop timing of the driving source P and the operation completion timing of the switching member 151 is minute, and the path switching can be controlled while the time interval between the completion time of the conveyance path switching and the time when the sheet S1 reaches the switching point s.p. is sufficiently secured and substantially maintained. However, since the effect by the spring is sufficient, the driving time of the driving source P to switch the switching member 151 by driving of the solenoid becomes long as compared with that in the first exemplary embodiment. Accordingly, in the case where the effect of the spring is sufficiently high in the arrangement illustrated in FIGS. 10A and 10B, it takes time to drive the driving source P to switch the switching member 151 from the second position to the first position, as compared with the case where driving of the driving source P is stopped and the switching member 151 is switched from the first position to the second position. Even in such a case, when the switching member 151 is switched from the second position to the first position as illustrated in FIG. 7B according to the second exemplary embodiment, start of switching of the switching member 151 at an earlier timing of the first timing and the second timing is effective.

The modification of the second exemplary embodiment is different from the second exemplary embodiment in that, when the switching member 151 is moved from the second position to the first position in step S403 of the flowchart in FIG. 7B, the driving source P is driven. In the modification of the second exemplary embodiment, the case where the two movement timings of the conveyance switching member by driving of the driving source P are provided is described. Even in this case, the time interval between the completion time of the conveyance path switching and the time when the sheet S1 reaches the switching point s.p. can be sufficiently secured as in the first exemplary embodiment. Thus, stable path switching can be expected. When a driving input time of the driving source P is increased, a service life of an electric part may be shortened, and power consumption may be increased. For this reason, in terms of the service life of the electric part and reduction of the power consumption, the first exemplary embodiment is more preferable than the second exemplary embodiment.

A third exemplary embodiment is described. The operation of the switching member 151 is similar to the operation of the switching member 151 according to the first exemplary embodiment. Accordingly, description of the drawings is omitted.

In the third exemplary embodiment, to induce switching of the switching member 151 based on the trailing edge of the sheet S2 in the case where the switching member 151 is moved from the first position to the second position, a sheet conveyance interval is intentionally widened. This is particularly effective to conveyance of thin paper having a small size that is lowered in conveyance efficiency due to influence of charging. In the first exemplary embodiment and the second exemplary embodiment, when the path switching operation is performed while the trailing edge of the sheet S2 passes over the switching member 151, the sheet S2 and the switching member 151 may come into contact with each other depending on the conveyance interval. This may cause frictional charging or damage the sheet S2. In contrast, in the third exemplary embodiment, the sheet S2 is conveyed while passage of the trailing edge of the sheet S2 over the switching member 151 is surely secured.

The present disclosure is not limited to the above-described exemplary embodiments, and can be variously modified without departing from the spirit of the disclosure as a matter of course.

More specifically, each of the above-described first, second, and third exemplary embodiments is applied to the image forming apparatus including the electrophotographic mechanism of the intermediate transfer tandem type, but the image forming apparatus is not limited to the examples.

For example, each of the exemplary embodiments may be applied to an image forming apparatus including an electrophotographic mechanism of a direct transfer type that transfers the toner image formed on the photosensitive body to a sheet without through the intermediate transfer body. Each of the exemplary embodiments may also be applied to an image forming apparatus including an inkjet printing unit or an offset printing mechanism without being limited to the image forming apparatus including the electrophotographic mechanism.

According to the exemplary embodiments, the switching member can perform stable path switching operation.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-096300, filed Jun. 13, 2024, which is hereby incorporated by reference herein in its entirety.

What is claimed is:

1. A sheet conveyance device comprising:
a first conveyance path and a second conveyance path through which a sheet is conveyed;
a switching member configured to be switched to a first position for guiding a conveyed sheet to the first conveyance path, and a second position for guiding a conveyed sheet to the second conveyance path;
a moving mechanism including a solenoid, and configured to move the switching member to the first position and the second position; and
a control unit configured to control an energization state of the solenoid,
wherein when the control unit starts energization of the solenoid, the moving mechanism moves the switching member from the second position to the first position,
wherein when the control unit stops energization of the solenoid, the moving mechanism moves the switching member from the first position to the second position,
wherein a first timing is a timing earlier by a predetermined time than a timing when a leading edge of a sheet reaches the switching member, and a second timing is a timing when a trailing edge of a preceding sheet conveyed before the sheet passes through a position downstream by a predetermined distance from the switching member in a sheet conveyance direction, and
wherein in a case where the switching member is moved from the first position to the second position, the control unit stops energization of the solenoid at an earlier timing of the first timing and the second timing.

2. The sheet conveyance device according to claim 1, wherein in a case where the switching member is moved from the second position to the first position, the control unit starts energization of the solenoid at the first timing.

3. The sheet conveyance device according to claim 1, wherein the control unit determines the first timing and the second timing based on a signal for starting image formation, the signal being output corresponding to each sheet.

4. An image forming apparatus comprising:
the sheet conveyance device according to claim 1;
an image forming unit configured to form an image on a sheet conveyed by the sheet conveyance device;
a sheet discharge tray to which the sheet is discharged; and
a duplex-printing conveyance path through which the sheet on which the image is formed on one surface by the image forming unit is conveyed to the image forming unit again,
wherein the first conveyance path is a path toward the duplex-printing conveyance path, and the second conveyance path is a path toward the sheet discharge tray.

5. An image forming apparatus comprising:
an image forming unit configured to form an image;
a first conveyance path and a second conveyance path through which a sheet is conveyed;
a switching member configured to be switched to a first position for guiding a conveyed sheet to the first conveyance path, and a second position for guiding a conveyed sheet to the second conveyance path;
a moving mechanism including a solenoid, and configured to move the switching member to the first position and the second position; and
a control unit configured to control an energization state of the solenoid,
wherein when the control unit starts energization of the solenoid, the moving mechanism moves the switching member from the second position to the first position,
wherein when the control unit stops energization of the solenoid, the moving mechanism moves the switching member from the first position to the second position, and
wherein in a state where a front end of the switching member is positioned in a sheet interval between a trailing edge of a conveyed first sheet and a leading edge of a second sheet conveyed after the first sheet in a sheet conveyance direction,
a predetermined time is a time from output of a signal for causing the image forming unit to start image formation on the second sheet until stop of energization of the solenoid to guide the second sheet to the second conveyance path, and
the predetermined time in a case where the sheet interval is a first distance is shorter than a predetermined time in a case where the sheet interval is a second distance shorter than the first distance.

6. The image forming apparatus according to claim 5,
wherein a second predetermined time is a time from output of the signal for causing the image forming unit to start image formation on the second sheet until start of energization of the solenoid to guide the second sheet to the first conveyance path, and
wherein the second predetermined time in a case where the sheet interval is a third distance is equal to the second predetermined time in a case where the sheet interval is a fourth distance shorter than the third distance.
